(19) United States
(12) Patent Application Publication
(10) Pub. No.: US 2023/0000060 A1
(43) Pub. Date: Jan. 5, 2023

(54) INSULATED HIVE STRUCTURE

(71) Applicant: Morris Wayne Hughes, III, Marietta, GA (US)

(72) Inventor: Morris Wayne Hughes, III, Marietta, GA (US)

(21) Appl. No.: 17/857,504

(22) Filed: Jul. 5, 2022

Related U.S. Application Data
(60) Provisional application No. 63/217,908, filed on Jul. 2, 2021.

(51) Int. Cl. A01K 47/06

(52) U.S. Cl. CPC A01K 47/06

(57) ABSTRACT

An apparatus for housing insects, such as honeybees, is provided. A main body includes a plurality of insulated outer walls, and each wall includes an outer surface, an inner surface, and a thermal insulating layer therebetween. The walls are oriented substantially vertically and arranged to define a central chamber having a top opening and a bottom opening. An aperture defined in at least one wall creates a passage between the central chamber and an outside area. An exterior frame is attached to the outer surface of the walls. The exterior frame includes a top crosspiece, a bottom crosspiece, and one or more vertical supports connecting the top crosspiece and the bottom crosspiece. A removable insulated lid is sized to cover the top opening of the main body. A solid base is sized to cover the bottom surface of the main body and configured to support the main body.

### RELATED APPLICATION

This application claims the benefit of priority to U.S. Provisional Application No. 63/217,908 on filed Jul. 2, 2021, which is hereby incorporated by reference herein in its entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to an apparatus for maintaining honeybees within a compound unit, and more specifically to a modular insulated enclosure for maintaining honeybees to reduce stress on the hive, improve colony health, and increase honey production.

### BACKGROUND

Conventional honeybee hives are made of wood since the material provides manufacturing efficiencies, including being cost effective, solid, easy to manufacture, and easy to maintain. However, these efficiencies in manufacturing are not necessarily correlated with efficiencies in the honeybee's internal hive conditions. The wood in conventional hives does not provide sufficient thermal insulation for the hives. That is, the wood does not prevent heat gains or losses due to environmental factors (e.g., external temperature, sun exposure, etc.) and creates excessive temperature fluctuations. Condensation can occur on the lids and walls of a conventional wooden hive when the external temperature is below the internal dew point of the hive. Condensed water can drip onto the bees, causing death in cold conditions. Moreover, prolonged moisture on walls can result in moldy hive conditions and spoiled honey stores, leading to mold and fungal growth within the hive which contributes to other diseases such as chalkbrood and Nosema (e.g., Nosema apis and/or Nosema ceranae). Weaker colonies cannot survive these conditions.

Many hives utilize ventilated lids or covers to address the condensation issues with wooden hives. The ventilated lids allow warm humid air from inside the hive to escape before it can condense. Thus, use of ventilated lids may lower the air temperature and reduce the humidity in the hive. This lowering of air temperature and reduction in humidity represents a significant loss of energy. When the energy is lost to the atmosphere, the bees must gather and consume additional food and water to replace the energy (e.g., to maintain necessary temperature and humidity). In particular, the honeybees generate heat with their bodies by shivering, cooling by fanning with their wings, and humidity by working water droplets. The process of regulating hive temperature and humidity using heat, air flow, and water vapor generated by the bees is an energy-intensive process.

Still further, pests such as hive beetles may invade colonies that reside in conventional wooden hives. Many beekeepers locate hives in full sun because higher temperatures and drier soil conditions are unfavorable for these pests. Moving energy inefficient wooden hives into full sun has created a need for more ventilation in the hives. Accordingly, beekeepers have introduced screened bottom boards, which allows for additional ventilation. However, the ventilated bottom boards create a large attack vector through the hive bottom in addition to the large hive entrances and ventilated covers. The openings used for ventilation are often exploited by pests to gain access. These openings also compromise the integrity of the hive's microclimate.

Honeybees become stressed, because of their weakened physical defenses against pests, the large fluctuations in temperature created by the conventional hives (e.g., solar heat gain during the day and heat loss at night), and the inability to maintain stable humidity levels due to the large amount of ventilation. This stress makes the colony less productive, more defensive, and more easily susceptible to diseases.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

An insulated hive helps to create conditions that favor the honeybee and its natural habitat. In particular, the insulating capabilities of the hive can be adjusted to reduce the effects of the ambient external environment (e.g., external temperature, external humidity, exposure to sun, etc.) on the internal conditions of the hive. By enclosing or substantially enclosing the hive within a thermally insulated structure, presence of condensation on internal surfaces of the hive are significantly reduced, particularly in colder conditions. Further, an insulated hive helps slow the movement of energy in the form of heat through the walls which helps stabilize the internal conditions.

In some embodiments, a sump area may be added at the bottom of the hive to encourage water vapor condensation in a single location. Accordingly, the sump may leave water at the bottom of the hive where honeybees can gather it for reuse while retaining energy expended by the bees to warm and humidify the air. Moreover, the sump may help to prevent water from condensing in other undesirable areas of the hive. Thus, the sump helps to lower the possibility of moisture related issues that negatively impact colony health during winter.

Removing upper ventilation can help the bees retain the energy expended conditioning the microclimate of the hive. In particular, removing the upper ventilation reduces or eliminates loss of heat and/or humidity through the lid of the hive, potentially representing a significant saving in energy.

In embodiments, beveled outer edges and precise machining can be used to reduce or eliminate spaces between components of a modular hive structure. Additionally, in some embodiments, sealants such as caulking and/or adhesive tape may be used to further restrict spaces between the modular components of the hive. Machining precisely fitting joints between components reduces vectors for pest attacks such as ants and small hive beetles. Moreover, entrances into the hive structure can also be restricted to relatively narrow passages. Restricting an entrance size can reduce hive vulnerability to pests, including ants, wax moths, small hive beetles, and Asian Giant Hornets. Moreover, a number of entrances can be restricted to be relatively low. Thus, attack vectors for invading pests are greatly reduced. Reducing the attack vectors reduces the need for guard bees, as the bees only need to guard a few small openings to secure their hives. This reduction in the number of guard bees means that more bees may contribute to honey production and other behaviors that are more beneficial to the colony and lessen defensive and aggressive behaviors. Additionally, the reduced attack vectors help to reduce overall stress among bees in the colony, which contributes to healthier colonies and better demeanor.

The reductions in stress and energy loss may, among other benefits, help to reduce colony disease and loss, which increases crop production in the colonies and thus yields financial benefit to beekeepers. The insulated hive structure also retains the modularity of conventional hive structures required for beekeepers to adequately manage their colonies.

The insulated hive structure allows for beehives to be moved into the shade, where it is less taxing on beekeepers to perform their work. Moving the insulated hive structure into the shade is also beneficial to the honeybee's microclimate, as it further reduces the environmental impact on the hive's microclimate by reducing exposure to direct sunlight. Accordingly, less energy is required to be expended by the bees to maintain the stability of the hive's internal conditions.

In a first aspect, the present disclosure may relate to an apparatus for housing honeybees. The apparatus may include a main body including a plurality of insulated outer walls, with each of the plurality of insulated outer walls comprising an outer surface, an inner surface, and a thermal insulating layer separating the outer surface and an inner surface, wherein the plurality of outer walls are oriented substantially vertically and arranged in a substantially polygonal formation to define a central chamber having a top opening and a bottom opening. An aperture may be defined in at least one of the plurality of insulated outer walls, the aperture defining a cylindrical passage between the central chamber and an outside area. An exterior frame may be attached to the outer surface of the plurality of insulated outer walls, the exterior frame comprising a top crosspiece adjacent to an upper edge of the plurality of insulated outer walls, a bottom crosspiece adjacent to a lower edge of the plurality of insulated outer walls, one or more vertical supports connecting the top crosspiece and the bottom crosspiece, a removable insulated lid, sized to cover the top opening of the main body. The apparatus may further include a solid base sized to cover the bottom surface of the main body and configured to support the main body.

In another aspect, the present disclosure may relate to an apparatus for housing honeybees that includes a main body having a plurality of insulated outer walls, each of the plurality of insulated outer walls comprising an outer surface, an inner surface, and a thermal insulating layer separating the outer surface and an inner surface. The plurality of insulated outer walls are oriented substantially vertically and arranged in a substantially rectangular formation to define a central chamber having a top opening and a bottom opening. The apparatus includes a cylindrical aperture defined in at least one of the plurality of insulated outer walls, the aperture defining a cylindrical passage between the central chamber and an outside area. At least one entry tube may be sized and shaped to fit within the cylindrical aperture, the entry tube formed from a material selected from one or more of: plastic, wood, a composite material, or metal. An exterior frame may be attached to the outer surface of the plurality of insulated outer walls, the exterior frame comprising a top crosspiece disposed along an upper edge of the plurality of insulated outer walls, a bottom crosspiece disposed along a lower edge of the plurality of insulated outer walls, and a plurality of vertical supports connecting the top crosspiece and the bottom crosspiece. The top crosspiece has a beveled top surface, and the bottom crosspiece has a beveled bottom surface. A removable insulated lid may be sized to cover the top opening of the main body, the removable insulated lid comprising a beveled lower edge configured to mate with the beveled top surface of the top crosspiece. A solid base may be sized to cover a bottom surface of the main body and configured to support the main body, the base defining a sump for collecting liquid or condensation. The base may include a beveled upper edge configured to mate with the beveled bottom surface of the bottom crosspiece, and wherein the base includes a removable panel at a bottom surface of the base.

In yet another embodiment, the disclosure may relate to an apparatus for housing honeybees, comprising a main body including a plurality of insulated outer walls. Each of the plurality of insulated outer walls includes an outer surface, an inner surface, and a thermal insulating layer separating the outer surface and an inner surface. The plurality of outer walls are oriented substantially vertically and arranged to define a central chamber having a top opening and a bottom opening. The apparatus may include an aperture defined in at least one of the plurality of insulated outer walls, the aperture defining a cylindrical passage between the central chamber and an outside area. The apparatus may further include an insect trap comprising a cavity within a particular insulated outer wall, of the plurality of insulated outer walls, the cavity being inaccessible from the central chamber, a drawer disposed within the cavity, the drawer being configured to receive bait, and an opening in the particular insulated outer wall, the aperture connecting the cavity to an external environment. An exterior frame may be attached to the outer surface of the plurality of insulated outer walls. The exterior frame may include a top crosspiece adjacent to an upper edge of the plurality of insulated outer walls, a bottom crosspiece adjacent to a lower edge of the plurality of insulated outer walls, and one or more vertical supports connecting the top crosspiece and the bottom crosspiece. A removable insulated lid may be sized to cover the top opening of the main body. A solid base may be sized to cover the bottom surface of the main body and configured to support the main body.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is a perspective view of an insulated hive structure in accordance with an embodiment of the present invention;

FIG. 2 is a perspective view of a main body portion of the insulated hive structure;

FIG. 3 is a cutaway view of a wall of the insulated hive structure;

FIG. 4 is a partial cutaway perspective view of an insulated hive structure in accordance with another embodiment of the present invention;

FIG. 5 is a graph showing a comparison of a temperature drop in a traditional hive structure and the insulated hive structure;

FIG. 6 is a graph showing a comparison of a temperature increase in a traditional hive structure and the insulated hive structure; and

FIG. 7 is a graph showing a comparison of absolute humidity levels over time in a traditional hive structure and the insulated hive structure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of an insulated beehive structure, embodiments of the present disclosure are not limited to use only in this context.

### I. Apparatus Overview

This overview is provided to introduce a selection of concepts in a simplified form that are further described below. This overview is not intended to identify key features or essential features of the claimed subject matter. Nor is this overview intended to be used to limit the claimed subject matter's scope.

The insulated hive apparatus includes a main body, a lid, and a base. The main body includes insulated walls, generally vertically oriented and disposed to define a central chamber in which a beehive can retained. Each of the walls includes an inner surface, an outer surface, and a thermally insulating layer separating the inner surface and the outer surface. A top surface and a bottom surface of the main body are open.

The main body further includes a support structure attached to the outer surface of the insulated walls. The support structure includes a top crosspiece disposed oriented substantially horizontally and attached at or near a top edge of each of the insulated outer walls. A top surface of the top crosspiece may include a beveled edge. A bottom crosspiece disposed oriented substantially horizontally and attached at or near a bottom edge of each of the insulated outer walls. A bottom surface of the bottom crosspiece may include a beveled edge. One or more vertical support members extend substantially vertically along the outer surface of the insulated outer walls to connect the top crosspiece and the bottom crosspiece.

The lid may include an insulated panel sized to completely cover the top surface of the central chamber. In embodiments, the lid includes a bottom surface, a top surface, and an insulating layer that separates the bottom surface from the top surface. The lid may further include a lower edge that is beveled and sized to contact all side walls of the hive and mate with the beveled top surface of the top crosspiece.

The base may include an insulated panel sized to completely cover the bottom surface of the central chamber. In embodiments, the base includes a bottom surface, a top surface, and an insulating layer that separates the bottom surface from the top surface. The base may define a sump or other reservoir for retaining a liquid (e.g., condensed water vapor) that may accumulate within the central chamber. The base may include an upper edge that is beveled and sized to mate with the beveled bottom surface of the bottom crosspiece.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

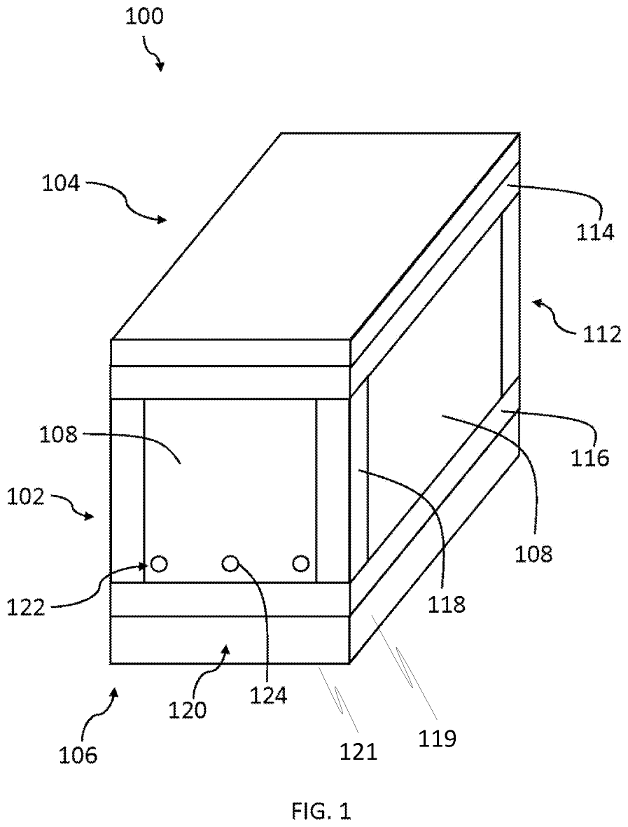

FIG. 1 shows a perspective view of an insulated hive system 100. The insulated hive system 100 may be located in an outdoor area for use by a colony of insects, such as honeybees. The insulated hive system 100 includes a main body or brood box 102, a lid 104, and a base 106. In some embodiments, the hive system 100 may also include additional boxes, known as “supers” at an upper portion of the hive. The supers may be used for honey storage, particularly during spring nectar flow.

The main body 102 includes a plurality of insulated walls 108. The insulated walls 108 are arranged to define a central chamber 110 (a brood chamber). As shown in FIG. 1, there are four insulated walls 108, arranged to define a rectangular central chamber or brood chamber 110. However, those of skill in the art will appreciate that more or fewer walls could be used in forming the central chamber, and that the walls may be of varying sizes and/or shapes, such that the shape of the central chamber can be varied. That is, the central chamber may be formed to be any useful shape.

The main body 102 further includes an external support structure 112 attached to the insulated walls 108. The external support structure 112 may provide structural support to the main body 102. In embodiments, the external support structure 112 may be formed from a polyvinyl chloride (PVC) material, wood, or other relatively strong materials. In embodiments, the external support structure 112 may be affixed to the insulated walls 108 using mechanical fasteners, such as screws, nails, and/or staples. Additionally, or alternatively, the external support structure 112 may be affixed to the insulated walls 108 using an adhesive, such as caulk, wood glue, and/or PVC glue having a low concentration of volatile organic compounds (e.g., a low-VOC PVC glue).

The external support structure 112 may include a top crosspiece 114 located at or near an upper edge of the insulated walls 108, a bottom crosspiece 116 located at or near a lower edge of the insulated walls 108, and one or more vertical supports 118.

Each of the vertical supports 118 may extend between the top crosspiece 114 and the bottom crosspiece 116, along the outer wall 108. As shown in FIG. 1, the vertical supports 118 are disposed at or near side edges of the insulated walls 108 to reinforce corners of the main body 102. However, those of skill in the art will appreciate that more or fewer vertical supports may be used without altering the scope of the invention. Moreover, the vertical supports may be located in different positions with respect to the outer walls 108 without altering the scope of the invention.

The insulated hive system includes a lid 104. The lid 104 is sized to cover a top surface of the main body 102, and to mate with the top crosspiece 114. In embodiments, the lid 104 may cover the top surface of the central chamber 110, such that weather elements such as water and sunlight are prevented from reaching the central chamber.

In embodiments, the lid 104 includes an outer surface and an inner surface. The outer surface is the exterior surface of the lid 104, and is exposed to outdoor elements, including rain, sunlight, wind, and the like. In embodiments, the outer surface is made from metal such as aluminum sheeting or galvanized steel, though other weather-resistant materials may be used without departing from the scope of the invention. The inner surface is the layer of the lid 104 that is adjacent to the central chamber 110. In embodiments, the inner surface may be formed from wood, such as wood veneer or plywood. In embodiments, a resawn wood veneer may be used to form the inner surface because resawn wood contains relatively lower amounts of volatile organic compounds (VOCs), as compared to conventional wood veneers and plywood.

In embodiments, the lid 104 includes a thermally insulating layer that separates the outer surface from the inner surface. The thermally insulating layer may be formed from a thermally insulating material. In embodiments, the thermally insulating material may be a water-resistant insulation, such as extruded polystyrene insulation board that maintains thermal insulation properties (e.g., R-value) even in the presence of water. One such product is Owens Corning Foamular® insulation. Additionally, or alternatively, the thermally insulating layer may be formed from a cork-based insulation such as Thermacork®. Additionally, or alternatively, the thermally insulating layer may include an air insulation, a vacuum insulation layer, or any other layer that provides thermal insulation properties.

The insulated hive system 100 includes a base 106. The base 106 is sized to cover a bottom surface of the main body 102, and to mate with the bottom crosspiece 116. In embodiments, the base 106 may cover the bottom surface of the central chamber 110, such that weather elements such as water and sunlight are prevented from reaching the central chamber.

In embodiments, the base 106 includes an outer surface and an inner surface. The outer surface is the exterior surface of the base 106, and is exposed to outdoor elements, including rain, sunlight, wind, and the like. In embodiments, the outer surface is made from metal such as aluminum sheeting or galvanized steel, though other weather-resistant materials may be used without departing from the scope of the invention. The inner surface is the layer of the base 106 that is adjacent to the central chamber 110. In embodiments, the inner surface may be formed from wood, such as wood veneer or plywood. In embodiments, a resawn wood veneer may be used to form the inner surface because resawn wood contains relatively lower amounts of volatile organic compounds (VOCs), as compared to convention wood veneers and plywood.

In embodiments, the base 106 defines a reservoir or sump 120. The sump 120 may be a section within the base 106 configured to retain liquid, such as condensed water vapor. Including the sump 120 in the base encourages water vapor condensation in a location that yields warm, dry air upward into the central chamber and collects water within the sump 120 so that honeybees can gather the water for reuse. Additionally, including the sump 120 may help to prevent water from condensing and pooling in other undesirable areas of the hive, reducing the possibility of moisture related issues that negatively impact colony health.

In embodiments, the sump 120 may include a side wall 119 and a bottom surface 121. The side wall 119 and/or the bottom surface 121 may include a thermally insulating layer that separates the outer surface from the inner surface. The thermally insulating layer may be formed from a thermally insulating material. In embodiments, the thermally insulating material may be a water-resistant insulation, such as extruded polystyrene insulation board that maintains thermal insulation properties (e.g., R-value) even in the presence of water. One such product is Owens Corning Foamular® insulation. Additionally or alternatively, the thermally insulating layer may be formed from a cork-based insulation such as Thermacork®. Additionally or alternatively, the thermally insulating layer may include an air insulation, a vacuum insulation layer, or any other layer that provides thermal insulation properties. In other embodiments, the side wall 119 and/or the bottom surface 121 may be formed from a solid material, such as wood, plastic, PVC, and/or the like. In some embodiments, at least the bottom surface 121 may be formed from a mesh material. In some embodiments, the bottom surface 121 may comprise a removable panel. For example, the bottom surface 121 may include a panel that is removably attached to the side wall 119.

Accordingly, the insulated hive structure 100 substantially surrounds the bee colony with a thermally insulating layer, which reduces occurrence of water vapor condensation on internal surfaces (e.g., within the central chamber 110) as well as resists unwanted heat gains or losses. Moreover, because the main body 102, lid 104, and base 106 are substantially solid and do not include ventilation structures, energy expended by the bee colony residing in the insulated hive structure 100 to condition the microclimate within the central chamber 110 is mostly retained, and the air and water vapor that have been conditioned by the bee colony can be recycled, helping to reduce the total amount of energy expended by the bee colony to maintain the microclimate.

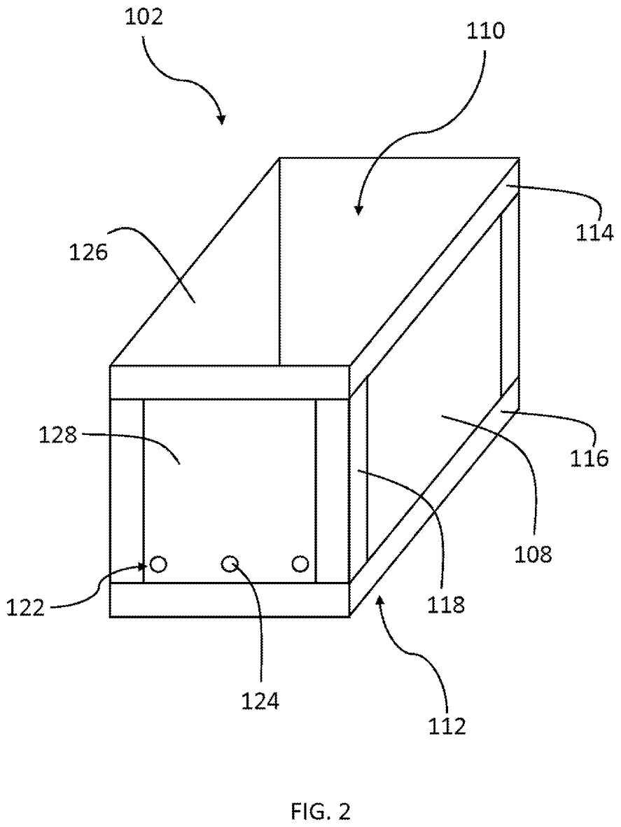

FIG. 2 shows a detailed perspective view of the main body 102. As discussed above with respect to FIG. 1, the main body 102 includes insulated walls 108. At least one of the insulated walls 108 includes an aperture 122 allowing passage between the central chamber 110 and an area external to the insulated hive system 100. In embodiments, the aperture 122 may be formed as a cylindrical aperture through the insulated wall 108. The aperture 122 may include a cylindrical tube 124 sized to fit within the aperture. The cylindrical tube 124 may extend beyond the insulated wall 108. The tube 124 may help to shield the central chamber 110 from weather (e.g., rain, sunlight, wind, etc.) in the outdoor area surrounding the insulated hive system 100.

Additionally, as shown in FIG. 2, each of the insulated walls 108 includes an inner surface layer 126 and an outer surface layer 128. The inner surface layer 126 is the layer of the insulated wall 108 that is adjacent to the central chamber 110. In embodiments, the inner surface layer 126 may be formed from wood, such as wood veneer or plywood. In embodiments, a resawn wood veneer may be used to form the inner surface layer 126 to reduce volatile organic compounds (VOCs) present in the inner surface layer, as compared to conventional wood veneers and plywood.

The outer surface layer 128 forms the exterior surface of the insulated wall 108, and is exposed to the outdoor elements, including rain, sunlight, wind, and the like. In embodiments, the outer surface layer 128 is made from metal such as aluminum or galvanized steel, though other weather-resistant materials may be used without departing from the scope of the invention.

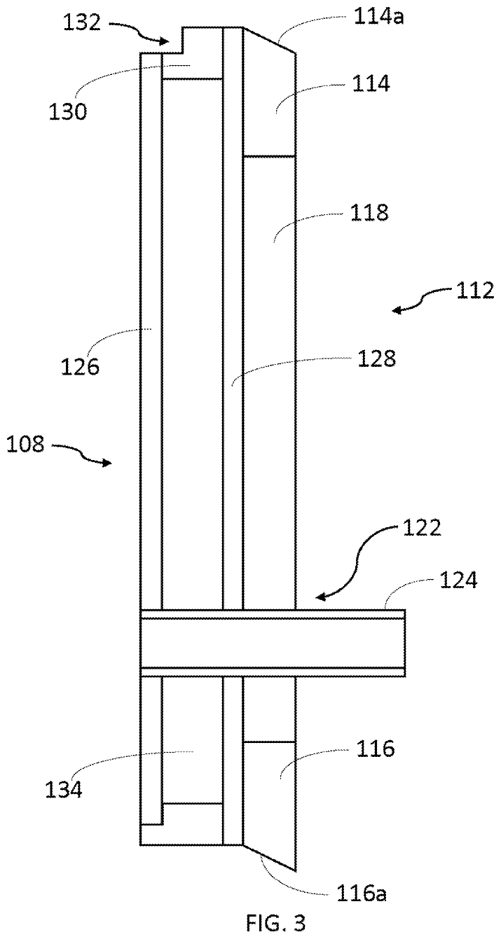

FIG. 3 shows a cutaway view of an insulated wall 108. As shown in FIG. 3, the insulated wall 108 includes the inner surface layer 126 and the outer surface layer 128, separated by a thermally insulating layer 134.

The thermally insulating layer 134 separates the inner surface layer 126 from the outer surface layer 128. The thermally insulating layer 134 may be formed from a thermally insulating material. In embodiments, the thermally insulating material may be a water-resistant insulation, such as extruded polystyrene insulation board that maintains thermal insulation properties (e.g., R-value) even in the presence of water. One such product is Owens Corning Foamular® insulation. Additionally or alternatively, the thermally insulating layer may be formed from a cork-based insulation such as Thermacork®. Additionally or alternatively, the thermally insulating layer may include an air insulation, a vacuum insulation layer, or any other layer that provides thermal insulation properties.

Additionally, one or more of the insulated walls 108 includes a top rim 130. The top rim 130. The top rim 130 may help to support weight and maintain shape of the insulated wall 108. The top rim 130 may include a slot or dado cutout 132 along an inner edge of the top rim, closest to the central chamber 110. The dado cutout 132 is preferably sized to allow one or more frames (not shown) to rest on the top rim 130, such that supports of the frames rest within the dado cutout 132, and the frames rest in a suspended fashion within the central chamber 110. In embodiments, the bee colony may construct honeycomb and/or other structures on the one or more frames. In some embodiments, each of the insulated walls 108 may include a top rim 130 having dado cutout 132. In other embodiments, one opposing pair of insulated walls 108 may include a top rim 130 having dado cutout 132, while another set of opposing walls 108 may include a top rim 130 with no dado cutout.

The top crosspiece 114 of the external support structure 112 includes an upper surface 114a having a beveled edge. That is, the upper surface 114a may be oriented non-perpendicularly to the insulated wall 108 to which the top crosspiece 114 is attached. As shown in FIG. 3, the beveled edge slopes down from a side closest to the insulated outer wall 108 to a side furthest from the insulated outer wall. However, those of skill in the art will recognize that other bevels may be used without departing from the scope of the invention. In embodiments, the lid (not shown) may have a complementary beveled edge to fit closely with the top crosspiece 114.

The bottom crosspiece 116 of the external support structure 112 includes a lower surface 116a having a beveled edge. As shown in FIG. 3, the beveled edge slopes down from a side closest to the insulated outer wall 108 to a side furthest from the insulated outer wall. However, those of skill in the art will recognize that other bevels may be used without departing from the scope of the invention. In embodiments, the base (not shown) may include a complementary beveled edge to fit closely with the bottom crosspiece 116. In some embodiments, the beveled edge of the upper surface 114a and the beveled edge of the lower surface 116a have complementary angles, such that multiple main body modules 102 may be stacked atop one another and fit closely together. In other embodiments, the beveled edge of the upper surface 114a and the beveled edge of the lower surface 116 have angles that are selected independently of one another.

Additionally, as shown in FIG. 3, the tube 124 extends through the insulated outer wall 108. The inner surface isolates the insulating layer 134 and helps to prevent the honeybees from eating or otherwise interacting with the insulating layer.

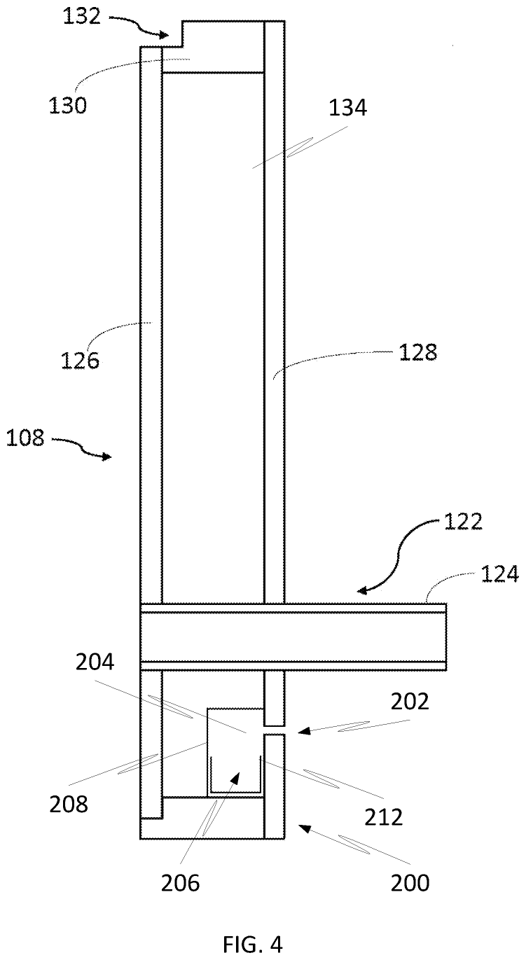

FIG. 4 shows an alternative embodiment cutaway perspective view of an insulated side wall 108 having an integrated trap 200 for capturing and retaining small hive beetles and/or other small pests. As shown, the trap 200 may be separated from the colony chamber and may intercept small hive beetles by providing a bait and relatively easier access to the bait without having to face or otherwise interact with bees. The trap 200 may comprise a narrow opening 202 providing access to a cavity 204. The opening 202 may be sized to attract small hive beetles, but too narrow for the honeybees to enter. In embodiments the cavity 204 may be a lined cavity in the side wall 108, preventing pests entering the cavity from accessing the insulation 134 of the side wall. In embodiments, the trap 200 may further comprise a pull-out drawer 206 sized to fit within the cavity 204. A user may access the drawer 206 through a portal or aperture 208 on a side of the hive 100.

The trap 200 may extend across the width of the hive 100. That is, the opening 202, the cavity 204, and/or the drawer 206 may have a length that substantially matches or coincides with the length of the side wall 108. In embodiments, the drawer 206 forms a tray that slides in and out of the trap 200 through the portal 208. In embodiments, the drawer 206 may be configured to hold bait (e.g., honey, nectar, sugar water, and/or the like) to lure small hive beetles. The drawer 206 may be configured to prevent the small hive beetles from escaping. The portal 208 may be sized to receive the drawer 206. The drawer 206 may include a cover 212 that substantially closes the portal 208 when the drawer is fully inserted. Thus, the portal 208 may be closed to help prevent bees entering the trap 200.

In operation, the trap 200 may be isolated from the brood chamber of the hive 100. For example, the trap 200 may be disposed between the outer surface 112 and the inner surface 126 of a side wall 108. The opening 202 may be disposed in the outer surface 112, allowing access to the trap 200, without allowing access to the brood chamber. The trap 200 may be accessible via a portal 208 disposed in the side wall 108, through which the drawer 206 may be inserted into the trap. The drawer 206 may be disposed such that, when the drawer is fully inserted into the trap, the cover 212 substantially covers the portal 208, preventing access by insects.

Small hive beetles may enter the trap 200, via the opening 202, to access bait disposed in the drawer 206. Once the small hive beetles enter the trap 200, they may become stuck within the drawer 206. Bees may be prevented from entering the trap 200 based on the size of the opening 202, and by the cover 212 covering the portal 208. Intermittently, a user (e.g., a beekeeper) may check the trap 200 by removing the drawer 206. The user may clean out the trap 200, removing any small hive beetles collected in the drawer 206, and may provide new bait as needed.

Microclimate Regulation

As discussed above, the insulated hive structure 100 helps to regulate the microclimate inside the structure. In particular, the insulated hive structure 100 may help to regulate temperature, relative humidity, and/or absolute humidity within the central brood chamber, as compared to traditional (e.g., Langstroth) hives and/or the external environment.

A. Temperature Drop Comparison

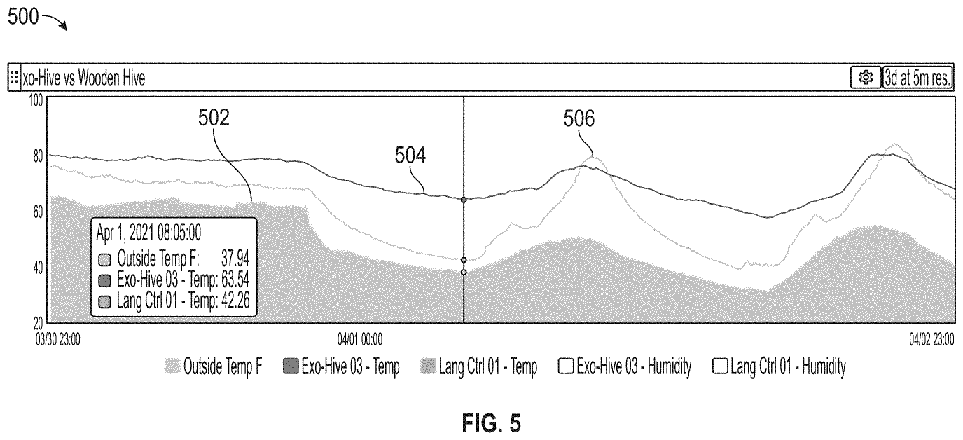

FIG. 5 shows a graph 500 showing a temperature curve 502 of an external area, together with a temperature curve 504 of an insulated hive system and a temperature curve 506 of a traditional wooden hive structure. All temperature curves 502, 504, 506 were captured over the same time period. As shown in FIG. 5, the insulated hive system 100 helps to prevent cooling in the brood chamber better than a traditional (e.g., Langstroth) hive structure when the external environment cools. In particular, the external area surrounding both a test hive (e.g., the insulated hive system 100) and a traditional hive experienced a sharp temperature drop. This external temperature drop is shown in FIG. 5. As shown in FIG. 5, the test hive had a significantly higher temperature at the onset of the sudden cooling, due to the insulating aspect of the test hive (e.g., as compared to that of a traditional wooden hive). In particular, the test hive has an R value of 5, versus the traditional hive R value of <1. Both hives had reduced entrances, solid floors, solid lids, and no ventilation other than the entrance itself. In a period of 8.5 hours the external temperature dropped from 61.48 degrees Fahrenheit to 37.94 degrees Fahrenheit; a difference of 23.54 degrees, and a 38% drop in temperature. The temperature within the traditional wooden hive dropped from 61.48 degrees Fahrenheit to 42.26 degrees Fahrenheit during the same time frame; a difference of 19.22 degrees, and a 31.3% drop in temperature. In comparison, the temperature within the test hive dropped from 76.46 degrees Fahrenheit to 63.54 degrees Fahrenheit over the same time frame; a difference of 12.92 degrees, and representing a 16.9% drop in temperature. Thus, the test hive was warmer at both the start of the temperature drop and at the time of the lowest external temperature. Moreover, with a 12.92-degree temperature drop in the test hive and a 19.22-degree temperature drop in the traditional wooden hive, the test hive reduced heat loss by 46%.

B. Temperature Rise Comparison

The faster temperature rises in a hive, the more bees are recruited to engage in fanning, a method the bees use to maintain a stable temperature in their hives. Hives may be placed in direct sunlight for various reasons, including to discourage pests. However, the conditions created by placing the hive in direct sunlight are generally unfavorable for the bees. Because traditional hives are constructed from wood and other materials with poor resistance to heat, solar heat gain in traditional wooden hives is significant. The large amount of solar heat gain causes bees to start to fan, which represents a loss of workforce, energy, and food stores.

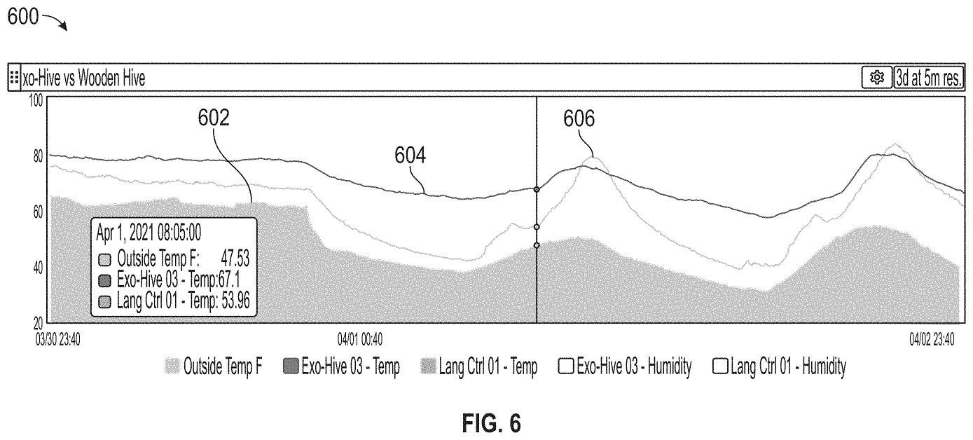

FIG. 6 shows a graph 600 showing a temperature curve 602 of an external area, together with a temperature curve 604 of an insulated hive system and a temperature curve 606 of a traditional wooden hive structure. All temperature curves 602, 604, 606 were captured over the same time period. As shown in FIG. 6, the insulated hive system 100 helps to resist temperature increase due to solar heat gain overall, and to reduce the speed at which the temperature rises, as compared to a traditional (Langstroth) wooden hive. As shown in FIG. 6, the external area surrounding both a test hive (e.g., the insulated hive system 100) and a traditional hive did not experience a significant rise in temperature, even though the sun came out. In particular, the outside temperature increased from a low of 47.53 degrees Fahrenheit to a high of 49.84 degrees Fahrenheit, a change in temperature of 2.11 degrees Fahrenheit. During the same time, the traditional hive, which was positioned in direct sunlight, saw a temperature increase from a low of 57.96 degrees Fahrenheit to a high of 78.44 degrees Fahrenheit, a temperature change of 20.48 degrees Fahrenheit. In comparison, the test hive, which was also positioned in direct sunlight, saw a temperature increase from a low of 67.1 degrees Fahrenheit to a high of 75.52 degrees Fahrenheit, a change of 8.42 degrees Fahrenheit. Accordingly, the traditional wooden hive gained heat from solar energy at a pace of 2.4 times that of the insulated hive. Moreover, as shown in FIG. 6, the test hive continued to gain heat even after the outside temperature started to fall. Further, when compared to the test hive, the traditional hive gained heat over a shorter period of time, in addition to gaining significantly more heat. Accordingly, the test hive provides higher lows, lower highs, and a much smoother temperature increase and decrease.

C. Absolute Humidity Comparison

Relative humidity cannot be used to accurately compare hive performance. Relative humidity is, as implied by the name, the amount of water vapor present in the air relative to the amount that the air could possibly hold—the amount of water vapor in the air as a percentage of the saturation point of at a given temperature. In other words, 80% relative humidity at 95 degrees Fahrenheit is a completely different amount of water vapor than 80% relative humidity at 60 degrees Fahrenheit, or even 105 degrees Fahrenheit.

To show differences in performance between the test hive and the traditional (Langstroth) wooden hive, absolute humidity, or the actual amount of water vapor in the air, is measured. The absolute humidity measurement allows for a more effective comparison of hive performance because the measurement is not affected by the temperature of the hives, and allows us to see when levels that impact varroa's fecundity are reached.

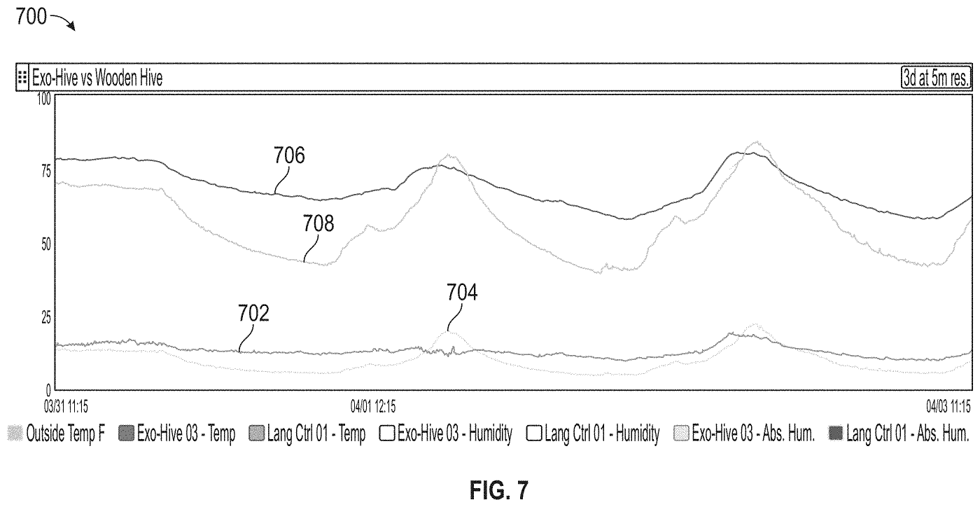

The main drivers of hive humidity are water gathering by the brood and evaporation of nectar to make honey. FIG. 7 shows a graph 700 showing an absolute humidity curve 702 of an insulated hive system and an absolute humidity curve 704 of a traditional wooden hive structure. FIG. 7 also shows a temperature curve 706 of the insulated hive system and a temperature curve 708 of the traditional wooden hive structure. All curves 702, 704, 706, 708 were captured over the same time period. FIG. 7 shows the temperature and absolute humidity of the traditional wooden hive in comparison with the temperature and absolute humidity of the test hive over the same time period. As shown in FIG. 7, the absolute humidity in the test hive is more stable than the absolute humidity of the traditional wooden hive. The variations in the absolute humidity likely represent a high amount of solar heat gain and the bees using humidity to help mitigate the rapid temperature change. Accordingly, the tests empirically show that the insulated test hive provides greater assistance in maintaining a stable absolute humidity, as compared to the traditional hive.

Absolute humidity levels of >30 g/m³ cause varroa to lose its fecundity. In general, varroa population grows along with the honeybee population. As nectar begins to flow, the honeybee colony increases brood activities, providing varroa a window to thrive by infecting the brood in the cells just before the cells are capped. Some bees possess a trait called Varroa Sensitive Hygiene. These bees are able to identify brood being exploited by the mite and remove them from the colony. However, many strains of honeybees do not possess this trait. Accordingly, beekeepers rely on chemical treatments called acaricides to mitigate the destruction of the pest. However, when absolute humidity levels in the hive increase above 30 g/m³, varroa fecundity (e.g., reproduction) is reduced, helping to mitigate varroa populations while still allowing the colony to reside comfortably in the hive. The test hive can easily reach an absolute humidity of 30 g/m³ or more. In contrast, for the traditional hive structure to reach an absolute humidity of 30 g/m³, upper ventilation must be greatly reduced or eliminated altogether, and a size of the entrance must be reduced. These conditions can lead to extremely high temperatures within the hive, which risks overheating the bees and leading to the bees abandoning the hive.

### II. System Configuration

Returning to FIG. 1, the figure shows one possible configuration of the insulated hive system 100. In embodiments, the base 106 may be placed on the ground or a stand to raise the base off of the ground. The main body 102 may be stacked on top of the base 106. The base 106 and main body 102 may have complementary beveled edges, helping to ensure that the main body is properly placed on top of the base and helping to ensure a close fit between the main body and the base. Optionally, one or more additional main bodies (not shown) may be stacked on top of the main body 102. The lid 106 may be stacked on top of the main body 102 (or the uppermost main body, if additional main bodies are stacked on top of main body 102). The main body 102 and the lid 104 may have complementary beveled edges, helping to ensure that the lid is properly placed on top of the main body, and helping to ensure a close fit between the main body and the lid. In some embodiments, the hive system 100 may further include intermediary bodies, such as, but not limited to, honey supers (e.g., honey storage bodies), feeders, and/or any other body useful in beekeeping.

### III. Apparatus/System Use

To use the insulated hive system, a configured insulated hive system is deployed in a suitable outdoor location. Thereafter, a honeybee colony may be introduced to the deployed insulated hive system. For example, the honeybee colony may be placed within the central chamber.

In use, the honeybee colony may construct honeycomb or other structures in the central chamber. For example, honeycomb or other structures may be built on one or more frames suspended within the central chamber. Additionally, the honeybee colony may work to condition the microclimate within the central chamber. For example, regardless of ambient temperature outside the insulated hive structure, the honeybee colony may regulate the in-hive microclimate of a beehive at the central chamber to maintain a temperature of 35° C. The insulated hive structure may help to preserve energy expended by the colony in conditioning the microclimate. Additionally, the insulated hive structure may help to mitigate effects of the ambient climate in the outside world on the microclimate within the central chamber.

### IV. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. An apparatus for housing honeybees, comprising:
a main body including a plurality of insulated outer walls, each of the plurality of insulated outer walls comprising:
an outer surface,
an inner surface, and
a thermal insulating layer separating the outer surface and an inner surface,
wherein the plurality of outer walls are oriented substantially vertically and arranged to define a central chamber having a top opening and a bottom opening;
an aperture defined in at least one of the plurality of insulated outer walls, the aperture defining a cylindrical passage between the central chamber and an outside area;
an exterior frame attached to the outer surface of the plurality of insulated outer walls, the exterior frame comprising:
a top crosspiece adjacent to an upper edge of the plurality of insulated outer walls,
a bottom crosspiece adjacent to a lower edge of the plurality of insulated outer walls,
one or more vertical supports connecting the top crosspiece and the bottom crosspiece,
a removable insulated lid, sized to cover the top opening of the main body; and
a solid base sized to cover the bottom surface of the main body and configured to support the main body.

2. The apparatus of claim 1, wherein the top crosspiece has a beveled top surface, and the bottom crosspiece has a corresponding beveled bottom surface.

3. The apparatus of claim 2, wherein the removable insulated lid comprises a beveled lower edge configured to mate with the beveled top surface of the top crosspiece.

4. The apparatus of claim 2, wherein the solid base comprises a beveled upper edge configured to mate with the beveled bottom surface of the bottom crosspiece.

5. The apparatus of claim 4, wherein the base includes a sump for collecting liquid or condensation and a solid lower surface.

6. The apparatus of claim 5, wherein the base comprises an insulated sidewall and a solid bottom.

7. The apparatus of claim 1, wherein the inner surface of one or more of the plurality of outer walls is formed from wood.

8. The apparatus of claim 1, wherein the outer surface of one or more of the plurality of outer walls is formed from metal.

9. The apparatus of claim 1, wherein the exterior frame is formed from polyvinyl chloride (PVC).

10. The apparatus of claim 1, wherein the exterior frame is formed from wood.

11. The apparatus of claim 1, wherein one or more of the plurality of outer walls comprises a top edge having a dado cut on a portion of the top edge adjacent to the inner surface, the dado cut defining a location for one or more frames to be suspended within the central chamber.

12. The apparatus of claim 1, wherein a particular outer wall, of the plurality of insulated outer walls, comprises an insect trap configured to collect small hive beetles.

13. The apparatus of claim 12, wherein the insect trap comprises:
a cavity within the particular outer wall, the cavity being inaccessible from the central chamber;
a drawer disposed within the cavity, the drawer being configured to receive bait; and
an opening in the particular outer wall, the aperture connecting the cavity to an external environment.

14. The apparatus of claim 13, wherein the insect trap is configured to lure small hive beetles, and wherein the opening is sized to permit access to the cavity by small hive beetles, and to prevent access to the cavity by honeybees.

15. The apparatus of claim 13, wherein the particular outer wall defines a portal for receiving the drawer, and wherein the drawer comprises a cover that is configured to prevent access to the cavity via the portal when the drawer is in a received position, such that the drawer is fully inserted into the cavity.

16. The apparatus of claim 1, wherein the plurality of insulated outer walls comprises four insulated outer walls arranged in a rectangular shape.

17. The apparatus of claim 1, wherein the thermal insulating layer of one or more of the plurality of outer walls comprises at least one of:
a water-resistant insulation,
a cork-based insulation,
an air insulation layer, or
a vacuum insulation layer.

18. The apparatus of claim 1, wherein the aperture is a cylindrical aperture, the apparatus further comprising an entry tube fit within the cylindrical aperture, and wherein the entry tube is sized to permit access by honeybees.

19. An apparatus for housing honeybees comprising:
a main body including a plurality of insulated outer walls, each of the plurality of insulated outer walls comprising:
an outer surface,
an inner surface, and
a thermal insulating layer separating the outer surface and an inner surface,
wherein the plurality of insulated outer walls are oriented substantially vertically and arranged in a substantially rectangular formation to define a central chamber having a top opening and a bottom opening;
a cylindrical aperture defined in at least one of the plurality of insulated outer walls, the aperture defining a cylindrical passage between the central chamber and an outside area;
at least one entry tube sized and shaped to fit within the cylindrical aperture, the entry tube formed from a material selected from one or more of: plastic, wood, a composite material, or metal;
an exterior frame, attached to the outer surface of the plurality of insulated outer walls, the exterior frame comprising:
a top crosspiece disposed along an upper edge of the plurality of insulated outer walls,
a bottom crosspiece disposed along a lower edge of the plurality of insulated outer walls,
a plurality of vertical supports connecting the top crosspiece and the bottom crosspiece,
wherein the top crosspiece has a beveled top surface, and
wherein the bottom crosspiece has a beveled bottom surface;
a removable insulated lid, sized to cover the top opening of the main body, the removable insulated lid comprising a beveled lower edge configured to mate with the beveled top surface of the top crosspiece;
a solid base sized to cover a bottom surface of the main body and configured to support the main body, the base including a sump for collecting liquid or condensation, and comprising a beveled upper edge configured to mate with the beveled bottom surface of the bottom crosspiece, and wherein the base includes a removable panel at a bottom surface of the base.

20. An apparatus for housing honeybees, comprising:
a main body including a plurality of insulated outer walls, each of the plurality of insulated outer walls comprising:
an outer surface,
an inner surface, and
a thermal insulating layer separating the outer surface and an inner surface,
wherein the plurality of outer walls are oriented substantially vertically and arranged to define a central chamber having a top opening and a bottom opening;
an aperture defined in at least one of the plurality of insulated outer walls, the aperture defining a cylindrical passage between the central chamber and an outside area;
an insect trap comprising:
a cavity within a particular insulated outer wall, of the plurality of insulated outer walls, the cavity being inaccessible from the central chamber,
a drawer disposed within the cavity, the drawer being configured to receive bait, and
an opening in the particular insulated outer wall, the aperture connecting the cavity to an external environment;
an exterior frame attached to the outer surface of the plurality of insulated outer walls, the exterior frame comprising:
a top crosspiece adjacent to an upper edge of the plurality of insulated outer walls,
a bottom crosspiece adjacent to a lower edge of the plurality of insulated outer walls,
one or more vertical supports connecting the top crosspiece and the bottom crosspiece,
a removable insulated lid, sized to cover the top opening of the main body; and
a solid base sized to cover the bottom surface of the main body and configured to support the main body.
